(19) United States
(12) Patent Application Publication
(10) Pub. No.: US 2006/0159833 A1
(43) Pub. Date: Jul. 20, 2006

(54) Waste pulp processing systems and apparatus

(75) Inventor: Peter V. Radatti, Conshohocken, PA (US)

Correspondence Address: MILLEN, WHITE, ZELANO & BRANIGAN, P.C., Suite 1400, 2200 Clarendon Boulevard, Arlington, VA, 22201, US

(73) Assignee: CyberSoft, Inc.

(21) Appl. No.: 11/039,097

(22) Filed: Jan. 20, 2005

(51) Int. Cl. A23L 1/212

(52) U.S. Cl. 426/615

(57) ABSTRACT

Waste pulp processing systems and apparatus are shown. Pulp is washed, desiccated, dried and may be ground, to provide a product that may be used in various foodstuffs and other compositions.

### FIELD OF THE DISCLOSURE

The present disclosure relates to waste pulp processing systems and apparatus.

### BACKGROUND OF THE DISCLOSURE

Food processing, especially of vegetables (a term used herein to encompass plants and their products, e.g., fruits, vegetables, berries, nuts, seeds, etc.) may generate large amounts of waste. For example, processing oranges for juice may generate pulp that is left over from the process. As large amounts of orange juice are consumed, large amounts of pulp are created.

Little or no use is often made of the waste pulp. The waste pulp may be frozen, for storage (which may be costly) or offered for sale, but waste pulp is generally not a consumer product. Waste pulp may also not permit easy disposal. For example, it may be difficult to dispose of large quantities of waste pulp in an environmentally sensitive process. For example, the possible effect of acidity from massive quantities of pulp could lead to environmentally detrimental consequences.

Aside from processes that produce waste materials in juicing or other processes, of course, various vegetables may be subject to a variety of processes for preservation and other reasons. For example, pasteurization may be used to preserve, chemical treatments may be added, etc.

Desiccation processes have been used for preservation and various other reasons. Desiccation may provide a useable product. For example, desiccation of fruits such as oranges, apples or bananas may lead to edible substances that are less likely to spoil, as the desiccated produce will lack moisture that would otherwise promote the growth of undesired microbes as well as possibly promote actively of undesired enzymes that otherwise would lead to spoilage.

Desiccation may also modify, through removal of water, the properties of the underlying material which may or may not be desired. For example, a fruit such as an orange is comprised of various compounds that provide its characteristics, such as flavor, color, nutrition, etc. These materials comprise a relatively small volume of the orange, however. The majority of the orange, as with many other vegetables, is water. Thus, desiccation methods may attempt to remove the water from the orange while preserving various compounds that provide the orange's characteristics.

### DETAILED DESCRIPTION OF PREFERRED EMBODIMENTS

A process of a preferred embodiment begins with quantities of waste pulp of a desired vegetable—that is, pulp which has been extracted in the course of processing vegetables. This waste pulp may be frozen, as waste pulp may be stored frozen. If the pulp is frozen, it will be thawed during the remainder of the process.

It may be possible that, in certain embodiments, a desired vegetable may have to be wholly or partially pulped, in addition to or instead of providing pulp. Therefore, desired vegetables may be pulped, using any suitable method in the arts, as part of a process of a preferred embodiment. A preferred pulping embodiment will peel, deseed and/or core the vegetable. The vegetable will then be mashed in order to produce pulp. The mashing process may be varied as desired according to any suitable process in order to vary consistency and/or other parameters.

The pulp is washed with water. The period of time the pulp is washed may be, in various embodiments varied according to retention of any desired characteristics. For example, in various preferred embodiments, it is desired to substantially remove any sugars and flavors present in the pulp. Accordingly, the period of washing is determined to be long enough to remove substantially remove those characteristics—those compounds present in the pulp—responsible for flavoring. In other embodiments, it may be desired to retain at least some flavoring, nutritive components, etc. so a shorter washing period is used. It should be noted that whatever the desired result, samples may be taken during the washing process to test the progress of the process. It should also be noted that other suitable liquids may be used to wash as well.

After the pulp is washed it is treated with a desiccant. The desiccant may be any suitable desiccant. In some embodiments, it may be selected according to the pulp material. For example, a neutralizing desiccant may be used with a certain pulp, as when lime is used with citrus pulp. The alkaline lime serves to neutralize the acidic citrus pulp and so a relatively neutral final product is produced.

Other embodiments may also choose the desiccant in order to provide a dried pulp final product with predetermined desired characteristics. For example, some but by no means all of the characteristics that may be desirably manipulated include but are not limited to flavor, nutrition, pH, etc.

In various preferred embodiments, the desiccant used is a baking soda and salt mixture. The proportions of baking soda and salt may vary as desired, that is, according to pulp type and volume, amount of desiccation desired, etc. In preferred embodiments, 50% baking soda to 50% salt is used and 1 lb. is used for every 5 lbs. of pulp. The mixture is thoroughly mixed with the pulp until it is evenly distributed throughout.

In another, especially preferred process, the desiccant used is calcium hydroxide (pickling lime.) One embodiment, for example, uses a proportion of 8 oz. of pickling lime to 44 lbs. of orange pulp. The mixture is thoroughly mixed with the pulp until it is evenly distributed throughout. It should be noted that other types of pickling lime solutions may be used, e.g., a slurry, etc.

The desiccant is applied to the pulp as desired. For example, if it is desired to decrease the flavor or other compounds the pulp may undergo desiccation for a relatively long period of time. So, for example, liquid desiccants may be run over the pulp for a period of time depending upon various variables, including the degree of desiccation sought, the nature of the pulp, etc. Gas desiccants may be imposed through jets or other suitable means. Solid desiccants may be mixed as suitable. The period of time that a desiccant is applied may vary according to any number of parameters. For example, a fruit pulp may require longer application at the height of ripeness, seasonal fluctuations in the crop might affect liquid levels thus requiring longer application, amount of desiccant applied, temperature, etc.

It is believed that the desiccant causes reverse osmosis in cells of the pulp—that is, water within the pulp cells is drawn out of the cells. Thus the pulp is desiccated.

The desiccated pulp may take on various forms, such as a slurry, cake, etc. For example, in an embodiment using a calcium hydroxide desiccant with orange pulp, the desiccated pulp is a grainy, wooden sort of semi-solid material.

The desiccant may have been, in various embodiments, recaptured for reuse. In such embodiments, the water removed from the pulp, as well as any residual components, may be removed from the desiccant if possible, using methods known in the art.

The desiccated pulp is usually damp, with liquid that has been drawn out of the cells during desiccation. Therefore, preferred embodiments wash the desiccated pulp using water or other suitable material. Washing with a suitable fluid may also serve to stop any further desiccating by removing the desiccant from the pulp. Washing may also assist in further removing any volatile compounds; e.g., that have been present in the desiccated pulp, created during any process, etc.

Following desiccating, and any washing, the pulp is dried. Drying may be in any suitable manner, e.g. spreading, air drying, etc. The use, type and nature of drying may be controlled if desired, in order to maintain or impart desired characteristics to the material.

The dried pulp can be used in various ways. For example, in preferred embodiments it is ground in order to provide a flour like consistency. The ground dried pulp may then be used as flour or other similar products in recipes and the like.

The dried material may also be used in various foods as desired, for example, for creams, sauces, additives, dips, dressings, etc.

The dried material may also be used as an organic filler in animal and plant foods, as well as other uses where a relatively inert material is desired.

In preferred embodiments the dried material is primarily comprised of cellular tissue which may be fiber or fiber like. Thus, it may provide certain health benefits as well when it is incorporated into an ingestible substance.

Any desired vegetable may be used. In some embodiments, the vegetable is chosen based on the availability of pulp—such as waste orange pulp. In other embodiments, the vegetable is chosen based on desired characteristics for the dried material. For example, if it is desired to provide a dried material with certain, comparatively sturdy characteristics, relatively fibrous vegetables or vegetables with relatively large fiber waste products would be used. Of course, various dried materials, although originally different types of pulp, may be blended as desired as well.

Some of the pulp that may be especially desirously used in various embodiments is derived from apples, cranberries, grapes, oranges and the other citrus fruits, tomatoes, cherries, peaches, pears, blueberries, strawberries, kiwi, pineapple, coconut, palm kernel, corn, flax, seeds, nuts, grass and weeds.

Of course, it should be noted that various additives may be added as desired. Additives may also be provided to the pulp before, during or after various processes. For example, it may be desired to add materials that will provide further structural matrix to a treated pulp, e.g., a hydrocolloid. A hydrocolloid compound will provide increased structure to trap various substances, e.g. gas, water, oil, etc. This may provide increased texture and taste, as well as ease of baking. Of course, other compounds may be used as well to provide further structural support, as well as other desired chemical and/or mechanical characteristics. Any suitable material may be used if desired. For example, proteins, edible glues, minerals, vitamins, flavoring, etc. may be added before during or after various processes of various embodiments.

The identification of categories of material for desiccation and/or specific materials with regard to various embodiments, it should be noted, is not meant to be all materials that may be used with various embodiments—any suitable material may be used. For example, a material may be chosen for physical quantities, such as high fiber levels providing for a resultant, relatively firm compound. Other materials may be chosen for nutritive reasons, such as vitamins, minerals, fats, oils, etc.

Although the various embodiments have been illustrated by reference to specific embodiments, it will be apparent that various changes and modifications may be made. Reference to “embodiment” or “an embodiment” means that a particular feature, structure or characteristic described in connection with the embodiment is included in at least one embodiment. The appearances of the phrase “various embodiments” or “preferred embodiments” appearing in various places throughout the specification are not necessarily all referring to the same embodiment. Moreover, various features and/or processes which have been described herein have been described in light of embodiments as well.

The various embodiments are intended to be protected broadly within the spirit and scope of the appended claims.

1. A method for processing waste pulp comprising:
washing said pulp;
desiccating said pulp;
drying said pulp, thereby providing a dried pulp material; and,
grinding said dried pulp material to a flour like consistency, thereby providing a ground dried pulp.

2. A method as in claim 1 further comprising desiccating said pulp with pickling lime.

3. A method as in claim 1 further comprising desiccating said pulp with a solution of baking soda and salt.

4. A method as in claim 1 further comprising desiccating said pulp with a neutralizing desiccant.

5. A method as in claim 1 further comprising desiccating said pulp with a desiccant chosen to provide said ground dried pulp with predetermined characteristics.

6. A method as in claim 1 further comprising washing said pulp in order to substantially remove any sugars present in said pulp.

7. A method as in claim 1 further comprising providing an additive to said pulp.

8. A method as in claim 7 further comprising providing an additive selected from the group consisting of: hydrocolloids, proteins, edible glues, minerals, vitamins, or flavoring.

9. A method for processing pulp comprising:
providing frozen waste pulp;
thawing said frozen waste pulp thereby obtaining pulp; and,
desiccating said pulp.

10. A method as in claim 9 further comprising washing said pulp.

11. A method as in claim 9 further comprising drying said pulp, thereby providing a dried pulp material.

12. A method as in claim 9 further comprising grinding said dried pulp material to a flour like consistency, thereby providing a ground dried pulp.

13. A method as in claim 9 further comprising desiccating said pulp with pickling lime.

14. A method as in claim 9 further comprising desiccating said pulp with a solution of baking soda and salt.

15. A method as in claim 9 further comprising desiccating said pulp with a neutralizing desiccant.

16. A method as in claim 9 further comprising drying said pulp, thereby providing a dried pulp material.

17. A method as in claim 16 further comprising grinding said dried pulp material to a flour like consistency, thereby providing a ground dried pulp.

18. A method as in claim 17 further comprising desiccating said pulp with a desiccant chosen to provide said ground dried pulp with predetermined characteristics.

19. A method as in claim 10 further comprising washing said pulp in order to substantially remove any sugars present in said pulp.

20. A method as in claim 9 further comprising providing an additive to said pulp.

21. A method as in claim 20 further comprising providing an additive selected from the group consisting of: hydrocolloids, proteins, edible glues, minerals, vitamins, or flavoring.

22. A method for processing pulp comprising:
washing said pulp;
desiccating said pulp;
drying said pulp, thereby providing a dried pulp material; and,
grinding said dried pulp material to a flour like consistency, thereby providing a ground dried pulp.

23. A method as in claim 22 further comprising desiccating said pulp with pickling lime.

24. A method as in claim 22 further comprising desiccating said pulp with a solution of baking soda and salt.

25. A method as in claim 22 further comprising desiccating said pulp with a neutralizing desiccant.

26. A method as in claim 22 further comprising desiccating said pulp with a desiccant chosen to provide said ground dried pulp with predetermined characteristics.

27. A method as in claim 22 further comprising washing said pulp in order to substantially remove any sugars present in said pulp.

28. A method as in claim 22 further comprising providing an additive to said pulp.

29. A method as in claim 28 further comprising providing an additive selected from the group consisting of: hydrocolloids, proteins, edible glues, minerals, vitamins, or flavoring.
